(19) United States
(12) Patent Application Publication
(10) Pub. No.: US 2014/0316660 A1
(43) Pub. Date: Oct. 23, 2014

(54) SEAT-INTEGRATED OCCUPANT PRESENCE DETECTOR

(71) Applicant: FORD GLOBAL TECHNOLOGIES, LLC, Dearborn, MI (US)

(72) Inventors: Jialiang Le, Canton, MI (US); Johnathan Andrew Line, Northville, MI (US); Manoharprasad K. Rao, Novi, MI (US)

(73) Assignee: FORD GLOBAL TECHNOLOGIES, LLC, Dearborn, MI (US)

(21) Appl. No.: 13/865,417

(22) Filed: Apr. 18, 2013

(51) Int. Cl. B60N 2/00

(52) U.S. Cl. CPC B60N 2/002
USPC 701/49

(57) ABSTRACT

A system includes a vehicle seat with an embedded presence detector that can detect a presence of an occupant and output a presence signal. A position controller is configured to receive the presence signal and adjust a position of the vehicle seat to a predetermined driving position in response to receiving the presence signal and prior to turning on a vehicle ignition.

### BACKGROUND

Passenger vehicles allow some or all vehicle occupants to adjust various characteristics of the occupant's seat in the vehicle. For example, some vehicle seats can be moved, reclined, tilted, etc. Moreover, some vehicle seats provide occupants with adjustable lumbar support. Some vehicles seats automatically adopt various configurations (e.g., height, tilt, recline, etc.) based on previous configurations set by the driver or another vehicle occupant. Vehicles with such features sometimes identify the occupant based on the key used to start the vehicle ignition. When the key is inserted into the ignition system, the vehicle automatically moves the seat according to the preferences of the occupant associated with the key.

### SUMMARY

An exemplary system includes a vehicle seat with an embedded presence detector that can detect a presence of an occupant and output a presence signal. A position controller is configured to receive the presence signal and adjust a position of the vehicle seat to a predetermined driving position in response to receiving the presence signal and prior to turning on a vehicle ignition.

An exemplary non-transitory computer-readable medium tangibly embodies computer-executable instructions that cause a processor to execute operations that include receiving an occupant presence signal and adjusting a position of a vehicle seat to a predetermined driving position in response to receiving the occupant presence signal and prior to turning on a vehicle ignition.

An exemplary vehicle includes a vehicle seat and a presence sensor embedded in the vehicle seat. The presence detector detects a presence of an occupant and outputs an occupant presence signal prior to vehicle ignition. The occupant presence signal indicates that the vehicle seat is occupied. The vehicle further includes a wake-up circuit that can enable the presence sensor prior to vehicle ignition and before the vehicle seat is occupied. The position controller receives the occupant presence signal and adjusts a position of the vehicle seat to a predetermined driving position in response to receiving the occupant presence signal and prior to turning on a vehicle ignition. The position controller can wait a predetermined length of time after receiving the occupant presence signal to adjust the position of the vehicle seat to the predetermined driving position. Additionally, the position controller can adjust the position of the vehicle seat to a predetermined park position after the vehicle is turned off.

### BRIEF DESCRIPTION OF THE DRAWINGS

FIG. 1 illustrates an exemplary vehicle having a seat-integrated occupant presence detector.

FIG. 2 illustrates an exemplary seat that may be used in the vehicle of FIG. 1.

FIG. 3 is a block diagram of exemplary components that may be incorporated into the vehicle of FIG. 1.

FIG. 4 illustrates a flowchart of an exemplary process that may be implemented by one or more components of the vehicle of FIG. 1.

### DETAILED DESCRIPTION

An exemplary system includes a vehicle seat with an embedded presence detector that can detect a presence of an occupant and output a presence signal. A position controller is configured to receive the presence signal and adjust a position of the vehicle seat to a predetermined driving position in response to receiving the presence signal and prior to turning on a vehicle ignition. Specifically, the position controller is able to adjust the seat before the occupant inserts the key into the ignition system. The presence sensor may further be used to enable other vehicle systems, such as a climate control system and entertainment system prior to ignition, and in some instances, before the occupant inserts the key into the ignition system.

FIG. 1 illustrates an exemplary vehicle 100 having a seat-integrated occupant presence detector. The vehicle 100 may take many different forms and include multiple and/or alternate components and facilities. While an exemplary vehicle 100 is shown, the exemplary components illustrated in the Figures are not intended to be limiting. Indeed, additional or alternative components and/or implementations may be used.

As illustrated in FIG. 1, the vehicle 100 includes doors 105 that allow an occupant to enter into a passenger compartment 110 of the vehicle 100. The passenger compartment 110 may include one or more seats 115 and controls that permit the occupant to operate the vehicle 100. Example controls (some of which are not shown) may include a steering wheel 120, brake and accelerator pedals, an instrument panel, a gear shifter, turn signals, climate controls, entertainment system controls, etc. The occupant may open the doors 105 by actuating a door handle 125.

In general, the vehicle 100 may be operated from the passenger compartment 110. After the occupant enters the vehicle 100, the occupant may insert and turn a key to start an ignition system. The period of time before the key is inserted into the ignition system may be referred to, generally, as “prior to ignition” or “prior to turning on a vehicle ignition” and the period of time after the key is inserted may be referred to, generally, as “after ignition.” Moreover, certain vehicles 100 may include “keyless” ignition, in which case “prior to ignition” may refer to the period of time before the vehicle 100 is started (by, e.g., pressing a start button) and “after ignition” may refer to the period of time after the vehicle is started (e.g., after the start button is pressed). After ignition, the occupant may drive or otherwise operate the vehicle 100. Although illustrated as a passenger vehicle, and in particular a car, the vehicle 100 may alternatively be any other form of transportation. For instance, the vehicle 100 may be a sport utility vehicle 100, passenger or commercial truck, a train, an airplane, a boat, etc.

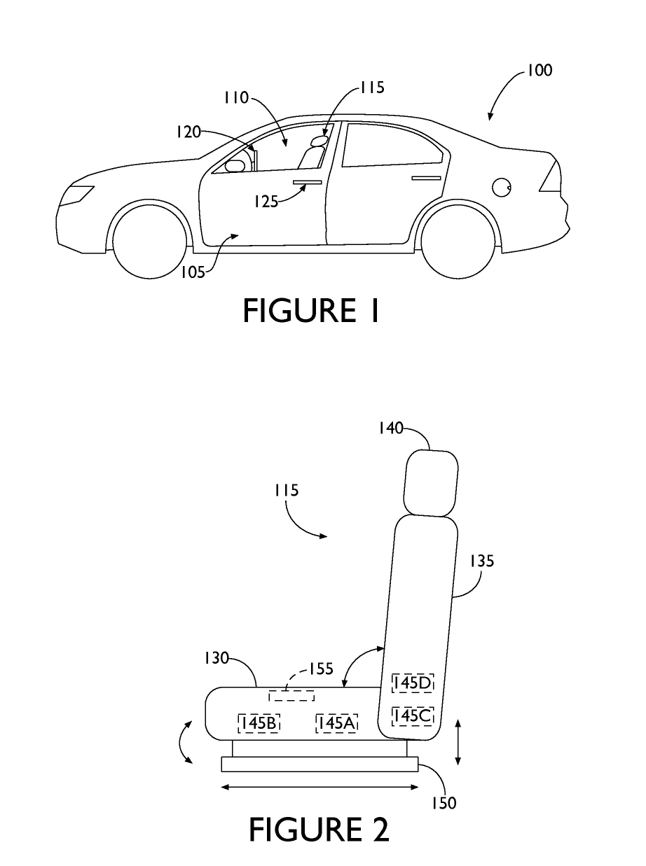

Referring now to FIG. 2, one or more seats 115 may be located inside the passenger compartment 110 of the vehicle 100. Only one seat 115 is shown in FIG. 2 for purposes of simplicity. The seat 115 may include a base 130, a backrest 135, and a headrest 140. These components may be configured to move relative to the vehicle 100 or relative to one another. The seat 115 may include any number of actuators 145 configured to provide additional degrees of freedom for moving the seat 115. For instance, the entire seat 115 may rest on rails 150 that allow the seat 115 to move forward, backward, or both, relative to the vehicle 100 to, e.g., make the passenger compartment 110 more comfortable for the driver by providing more or less legroom. That is, taller occupants may wish to move the seat 115 back to allow for more legroom while shorter occupants may wish to move the seat 115 forward to more easily reach the pedals. Thus, a first actuator 145A may be configured to move the seat 115 forward or backward while a second actuator 145B may be configured to tilt the entire seat 115 forward or backward relative to a floor inside the passenger compartment 110 of the vehicle 100. A third actuator 145C may be configured to raise or lower the height of the seat 115. A fourth actuator 145D may be configured to control rotation of, e.g., the backrest 135 relative to the base 130 of the seat 115. While four actuators 145 are shown in FIG. 2, the seat 115 may include any number of actuators 145. Indeed, a single actuator 145 may be configured to facilitate the movement of the first, second, third, and fourth actuators 145A-D shown in FIG. 2.

Each actuator 145 may be configured to control the position of one or more components of the seat 115 using any combination of mechanical and electronic components. For instance, each actuator 145 may be configured to receive control signals from other components in the vehicle 100 and manipulate the seat 115 or a portion of the seat 115 according to the control signal or signals received. For instance, one control signal may command the entire seat 115 to move forward while another control signal may command the backrest 135 to recline relative to the base 130. The respective actuators 145 may, in response to these control signals, manipulate the position of the seat 115 accordingly.

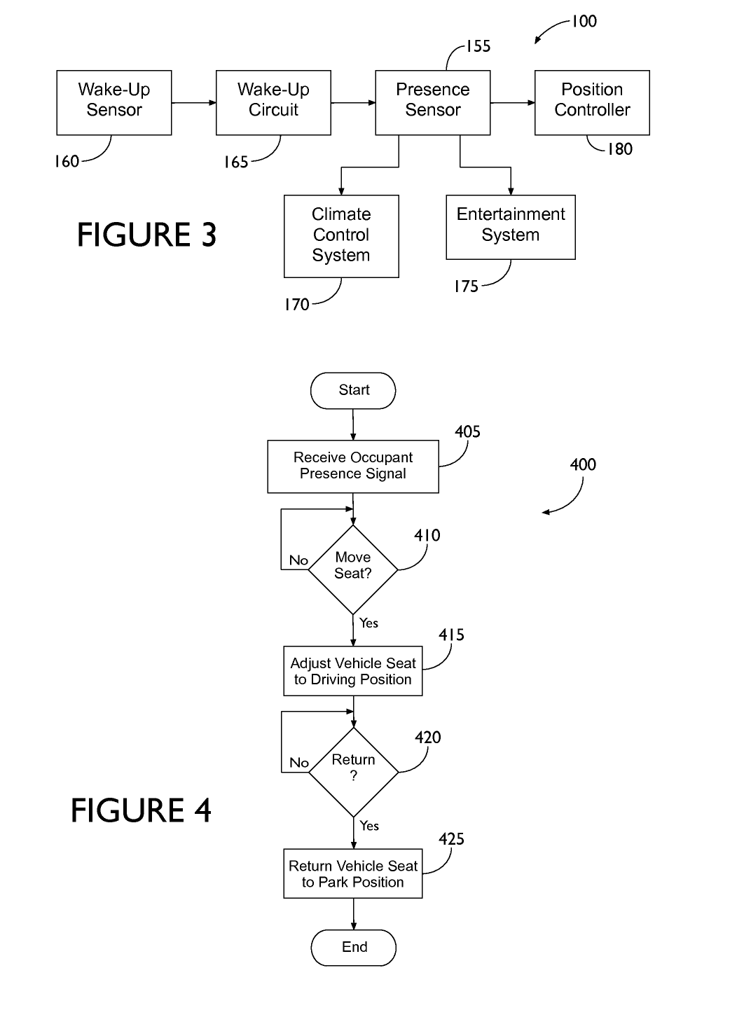

In one possible implementation, a presence sensor 155 may be embedded in the seat 115. As shown in FIG. 2, the presence sensor 155 is embedded in the base 130 of the seat 115. The presence sensor 155 may alternatively be embedded in the backrest 135, or the seat 115 may include multiple presence sensors 155 embedded in different parts of the seat 115. The presence sensor 155 may include any device configured to detect the presence of an occupant (e.g., detect when an occupant is sitting in the seat 115) and output a presence signal representing the presence of the occupant. Moreover, the presence sensor 155 may be configured to output a presence signal to one or more vehicle components to, e.g., enable those components when the occupant enters the vehicle 100 but before the ignition is started. The presence sensor 155 is discussed in greater detail below with respect to FIG. 3.

FIG. 3 is a block diagram of exemplary components that may be used in the vehicle 100 of FIG. 1 to control a vehicle seat, such as the seat 115 illustrated in FIGS. 1 and 2. FIG. 3 includes a wake-up sensor 160, a wake-up circuit 165, a climate control system 170, an entertainment system 175, the presence sensor 155, and a position controller 180.

The wake-up sensor 160 may include any sensing device configured to detect a presence of the occupant at or near the vehicle 100. In one possible approach, the wake-up sensor 160 may include a door state sensor integrated into the door 105 of the vehicle 100 and configured to detect the occupant when the door 105 is opened. That is, when the door 105 is opened, the wake-up sensor 160 may be configured to output a door state signal representing an open state. When the door 105 is closed, the wake-up sensor 160 may be configured to output a door state signal representing the closed state. The wake-up sensor 160 may be configured to identify the presence of the occupant at or near the vehicle 100 from other indications such as a location of a key fob relative to the vehicle 100 (e.g., within a predetermined distance from the vehicle 100), when the doors 105 are unlocked either remotely or with a key, when the trunk is opened, when an occupant touches a door handle 125, or the like. Accordingly, the wake-up sensor 160 may be configured to detect the occupant before the occupant enters the vehicle 100.

The wake-up circuit 165 may include any processing device configured to enable one or more components of the vehicle 100. The wake-up circuit 165 may be configured to receive the door state signal or other signals from the wake-up sensor 160. Based on the signals received from the wake-up sensor 160, the wake-up circuit 165 may be configured to determine whether to “wake up” one or more, if any, components of the vehicle 100. If so, the wake-up circuit 165 may be configured to output one or more wake-up signals to each component to be enabled in response to the output of the wake-up sensor 160. Various vehicle components, such as the presence sensor 155 and position controller 180, may be configured to receive the wake-up signal. Because the wake-up signal may be generated from the output of the wake-up sensor 160, the wake-up signal may be generated and transmitted to any number of vehicle components before the occupant enters the vehicle 100. In some instances, other vehicle components such as the climate control system 170 and entertainment system 175 may also be configured to “wake up” in response to receiving the wake-up signal.

The wake-up signal may provide power to the component being awoken. Alternatively, the wake-up signal may represent a command to a particular vehicle component to begin operating. For instance, one or more vehicle components may operate in a “sleep” or other low power mode when, e.g., the vehicle 100 is off. During the “sleep mode,” the operation of the component may be limited to checking whether the wake-up signal was received from the wake-up circuit 165. If so, the component may begin operating under normal conditions, discussed below. The component may continue to operate in the “sleep” mode until the wake-up signal is received or the vehicle 100 is started.

The climate control system 170 may be configured to control a temperature of the passenger compartment 110. The climate control system 170 may include any number of blowers that push heated or cooled air into the passenger compartment 110. The climate control system 170 may, in one possible approach, be configured to turn on or awaken from a “sleep” mode in response to the wake-up signal generated by the wake-up circuit 165 or an enable signal such as the presence signal generated by the presence sensor 155. In any event, the climate control system 170 may become enabled before turning on the ignition system, and in some instances, before the occupant enters the vehicle 100, giving the climate control system 170 time to initialize prior to turning on the ignition. This way, the climate control system 170 may be ready to provide the occupant with climate control options when or shortly after the occupant enters the vehicle 100. The climate control system 170 may also be configured to begin heating or cooling the passenger compartment 110 even before the occupant enters the vehicle 100. The climate control system 170 may also be configured to automatically turn off after a prescribed amount of time if, e.g., the vehicle ignition is not turned on during the prescribed amount of time. The climate control system 170 may also be temporarily turned off while the vehicle ignition is being turned on.

The entertainment system 175 may be configured to provide media content to one or more occupants. In one possible implementation, the entertainment system 175 may include a radio, music player, video player, navigation system, or the like. The entertainment system 175 may incorporate a human machine interface, such as a touchscreen configured to present media content and options to the occupant and receive selections from the occupant. The entertainment system 175 may be configured to initialize in response to a wake-up signal generated by the wake-up circuit 165 or an enable signal such as the presence signal generated by the presence sensor 155. The entertainment system 175 may therefore be ready to provide media content to the occupant as soon as or shortly after the occupant enters the vehicle 100 but before turning on the ignition system. The entertainment system 175 may also be configured to automatically turn off after a prescribed amount of time if, e.g., the vehicle ignition is not turned on during the prescribed amount of time.

The presence sensor 155 may be configured to detect the presence of the occupant and output a presence signal when the occupant is detected. As discussed above with respect to FIG. 2, the presence sensor 155 may be embedded in the seat 115. Therefore, the presence sensor 155 may be configured to output the presence signal when the occupant sits in the seat 115. The presence signal, therefore, may represent the presence of the occupant in the seat 115. In one possible implementation, the presence sensor 155 may include an electro-resistive sensor configured to deform when the occupant sits on the seat 115. The presence sensor 155 may be configured to output the presence signal according to the amount that the electro-resistive sensor has deformed to, e.g., provide information about the occupant. Characteristics of the presence signal, such as the voltage of the presence signal, may be proportional to the deformation of the electro-resistive sensor. A relatively high voltage may represent a greater amount of deformation, suggesting the presence of a larger occupant. A relatively low voltage may represent less deformation, suggesting the presence of a smaller occupant. Some other types of information that may be determined from the presence sensor signal may include the occupant's size, weight, whether the occupant is an adult or child, whether the occupant is actually an inanimate object (e.g., a purse, briefcase, book, etc.), whether the occupant is a pet, etc. The presence sensor 155 may be configured to operate at a relatively low power and may be enabled by the wake-up circuit 165, i.e., upon receipt of the wake-up signal. The presence sensor 155 may turn off when the vehicle 100 is turned off (e.g., the key is turned to the off position or removed from the ignition) and turn on in response to the wake-up signal received from the wake-up circuit 165. Therefore, the presence sensor 155 may be enabled prior to turning on the ignition system.

The position controller 180 may include any computing device configured to adjust a position of the vehicle seat 115 upon receipt of the presence signal, which as discussed above may be generated by the presence sensor 155 as soon as the occupant is detected in the seat 115. Therefore, the position controller 180 may be configured to adjust the position of the seat 115 as soon as the occupant sits down and prior to turning on the ignition system of the vehicle 100. The position controller 180 may be configured to adjust the position of the seat 115 to any number of predetermined positions such as a driving position and a park position. The driving position may include a position of the seat 115 previously set by the occupant. The drive position may also be selected as the position of the seat 115 at the time when the ignition was most recently turned off. The driving position, therefore, may represent the occupant's desired position of the seat 115 when operating the vehicle 100. The position controller 180 may be configured to move the seat 115 to the driving position as soon as the occupant is seated in the vehicle 100. The park position may include a position of the seat 115 based on calibration values that put the seat 115 in a position to allow for easier ingress and egress from the vehicle 100 than when the seat 115 is in the driving position. Accordingly, the position controller 180 may be configured to move the seat 115 to the park position as soon as the ignition is turned off

Generally, moving the seat 115 from the driving position to the park position includes moving the seat 115 back (e.g., toward the rear of the vehicle 100) along the rails 150 to make exiting the vehicle 100 easier for the occupant. By moving the seat 115 back, the park position may also make it easier for the occupant to enter the vehicle 100. Moving the seat 115 from the driving position to the park position may further or alternatively include changing any one or more of the height, tilt, or recline of the seat 115. Moving the seat 115 from the park position to the driving position may include moving the seat 115 forward (e.g., toward the front of the vehicle 100) to a position previously set by the occupant. Moreover, moving the seat 115 from the park position to the driving position may include changing any one or more of the height, tilt, or recline of the seat 115 to positions previously set by the occupant.

To adjust the position of the seat 115, the position controller 180 may be configured to output command signals to the actuators 145 illustrated above in FIG. 2 to move the seat 115 forward or backward, and/or change the height, tilt, or recline of the seat 115. The position controller 180 may be configured to access a memory device (not shown) that is configured to store values associated with the park position and the driving position. The memory device may be configured to store the values in one or more databases. The values associated with the park position may include calibration values while the values associated with the driving position may be set by the occupant.

In some possible implementations, the position controller 180 may be configured to confirm that the occupant is properly seated in the vehicle 100 prior to adjusting the seat 115. Instances where the position controller 180 may wait to adjust the seat 115 include instances where the occupant places something on the seat 115 but does not sit down in the vehicle 100, where the occupant sits partially on the seat 115 while one or both of the occupant's legs are outside the vehicle 100, or the like.

To confirm that the occupant is fully seated in the vehicle 100, the position controller 180 may be configured to adjust the seat 115 after the door 105 is closed. Therefore, the position controller 180 may be configured to receive the door state signal from the wake-up sensor 160 or a door 105 sensor (not shown) and adjust the position of the vehicle seat 115 to the driving position when the door state signal represents that the door 105 is closed (e.g., in a closed state). Thus, the position controller 180 may be configured to adjust the position of the seat 115 in response to both the presence signal and the door state signal. An alternative approach is for the position controller 180 to wait to adjust the position of the seat 115 for a predetermined amount of time after receiving the presence signal to give the occupant time to fully enter the vehicle 100. When the vehicle 100 is turned off, the position controller 180 may be configured to adjust the position of the seat 115 to the park position. The position controller 180 may be configured to keep the seat 115 in the park position until the occupant enters the vehicle 100 again.

The position controller 180 may be configured to receive the wake-up signal generated by the wake-up circuit 165. In one possible approach, the position controller 180 may be configured to generally operate in a low power mode or “sleep” mode while the vehicle 100 is turned off. Upon receipt of the wake-up signal, however, the position controller 180 may become enabled. In one possible approach, the position controller 180 may be configured to receive the wake-up signal from the presence sensor 155, or alternatively, the presence signal may enable the position controller 180.

In general, computing systems and/or devices, such as the wake-up circuit 165, the position controller 180, the climate control system 170, and the entertainment system 175, may employ any of a number of computer operating systems, including, but by no means limited to, versions and/or varieties of embedded operating systems, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance.

Computing devices generally include computer-executable instructions, where the instructions may be executable by one or more computing devices. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above. Various sensors, circuits, controllers and systems such as climate control system and entertainment system may be connected and operated by means of vehicle level networks such as CAN (Controller Area Network) and LAN (Local Area Network), etc.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

FIG. 4 is a flowchart of an exemplary process 400 that may be implemented with one or more of the vehicle components shown in FIG. 3. For instance, the process 400 may be implemented by, e.g., the position controller 180.

At block 405, the position controller 180 may receive the occupant presence signal generated by, e.g., the presence sensor 155. The presence signal may represent the presence of the occupant in the seat 115, and characteristics, such as voltage, of the presence signal may be used to identify information about the occupant.

At decision block 410, the position controller 180 may determine whether to move the seat 115 to the driving position. The position controller 180 may make such a determination based on various factors such as whether the presence signal was received, the door state (e.g., open or closed), or whether a predetermined amount of time has elapsed since the occupant was detected. If the position controller 180 decides to move the seat 115, the process 400 may continue at block 415. If the position controller 180 decides to not move the seat 115, the process 400 may return to block 410 until it is determined that the seat 115 should be moved.

At block 415, the position controller 180 may move the seat 115 to the driving position. As discussed above, moving the seat 115 to the driving position may include any one or more of moving the seat 115 forward (e.g., toward the front of the vehicle 100), changing the height of the seat 115, changing the tilt of the seat 115 relative to a floor inside the passenger compartment 110 of the vehicle 100, and changing the recline of the backrest 135 relative to the base 130 of the seat 115. The position controller 180 may adjust the seat 115 based on values previously set by the occupant. Alternatively, the drive position may also be selected as the position of the seat 115 at the time when the ignition was most recently turned off. These selected values may represent the occupant's desired position of the seat 115 while in the driving position.

At decision block 420, the position controller 180 may determine whether to return the seat 115 back to the park position. For instance, the position controller 180 may determine that the seat 115 should be returned to the park position when the vehicle 100 is turned off. Alternatively, the position controller 180 may determine to return the seat 115 to the park position when the door 105 opens. The opening of the door 105 may be detected from the door state signal. If the position controller 180 determines that the seat 115 should be returned to the park position, the process 400 may continue at block 425. Otherwise, the process 400 may repeat block 420 until such a determination is made.

At block 425, the position controller 180 may return the seat 115 to the park position. Generally, returning the seat 115 to the park position may include moving the seat 115 backward (e.g., toward the back of the vehicle 100) as well as changing the height, tilt, and recline of the seat 115 according to, e.g., calibration parameters stored in the memory device.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A system comprising:
a vehicle seat;
a presence sensor embedded in the vehicle seat and configured to detect a presence of an occupant and output an occupant presence signal;
a position controller configured to receive the occupant presence signal and adjust a position of the vehicle seat to a predetermined driving position in response to receiving the occupant presence signal and prior to turning on a vehicle ignition;
a wake-up sensor configured to detect when a vehicle door is in an open state and a closed state, and to output a door state signal representing one of the open state and the closed state; and
a wake-up circuit configured to receive the door state signal from the wake-up sensor, and to enable the presence sensor and the position controller when the door state signal indicates that the door is in the open state and before the vehicle seat is occupied.

2. The system of claim 1, wherein the presence sensor is configured to detect the presence of the occupant prior to turning on a vehicle ignition.

3. The system of claim 1, wherein the presence sensor is configured to detect when the occupant is sitting in the vehicle seat.

4. (canceled)

5. The system of claim 1, further comprising a climate control system, wherein the presence sensor is configured to enable the climate control system upon detection of the occupant and prior to turning on a vehicle ignition.

6. The system of claim 1, further comprising an entertainment system, wherein the presence sensor is configured to enable the entertainment system upon detection of the occupant and prior to turning on a vehicle ignition.

7. The system of claim 1, wherein the wake-up sensor comprises a door state sensor configured to identify and output a door state signal representing at least one of an open state and a closed state of a vehicle door.

8. The system of claim 7, wherein the position controller is configured to receive the door state signal and adjust the position of the vehicle seat to the predetermined driving position in response to receiving the occupant presence signal and the door state signal prior to turning on a vehicle ignition.

9. The system of claim 1, wherein the position controller is configured to wait a predetermined length of time after receiving the occupant presence signal to adjust the position of the vehicle seat to the predetermined driving position.

10. The system of claim 1, wherein the position controller is configured to adjust the position of the vehicle seat to a predetermined park position after the vehicle is turned off

11. The system of claim 1, wherein adjusting the position of the vehicle seat includes moving the vehicle seat in at least one of the following directions: forward, backward, up, and down.

12. The system of claim 1, wherein adjusting the position of the vehicle seat includes at least one of tilting and reclining the vehicle seat.

13. A non-transitory computer-readable medium tangibly embodying computer-executable instructions that cause a processor to execute operations comprising:
receiving an enable signal from a wake-up sensor, the enable signal indicating that a vehicle door is in an open state;
receiving an occupant presence signal after receiving the enable signal, and adjusting a position of a vehicle seat to a predetermined driving position in response to receiving the occupant presence signal and prior to turning on a vehicle ignition.

14. The non-transitory computer-readable medium of claim 13, wherein the occupant presence signal is received after the presence of an occupant is detected and prior to turning on a vehicle ignition.

15. The non-transitory computer-readable medium of claim 14, wherein the presence of the occupant is detected when the occupant sits in a vehicle seat.

16. The non-transitory computer-readable medium of claim 13, the operations further comprising:
receiving a door state signal representing a state of a vehicle door; and
adjusting the position of the vehicle seat to the predetermined driving position in response to receiving the occupant presence signal and the door state signal prior to turning on a vehicle ignition.

17. The non-transitory computer-readable medium of claim 13, the operations further comprising waiting a predetermined length of time after receiving the occupant presence signal to adjust the position of the vehicle seat to the predetermined driving position.

18. The non-transitory computer-readable medium of claim 13, the operations further comprising adjusting the position of the vehicle seat to a predetermined park position after the vehicle is turned off.

19. A vehicle comprising:
a vehicle seat;
a vehicle door corresponding to the vehicle seat;
a presence sensor embedded in the vehicle seat and configured to detect a presence of an occupant and output an occupant presence signal prior to vehicle ignition, the occupant presence signal indicating that the vehicle seat is occupied;
a wake-up sensor configured to detect when the vehicle door is in an open state and a closed state, and to output a door state signal representing one of the open state and the closed state;
a wake-up circuit configured to receive the door state signal from the wake-up sensor, and to enable the presence sensor prior to vehicle ignition, wherein the wake-up circuit is configured to enable the presence sensor when the door state signal indicates that the door is in the open state and before the vehicle seat is occupied; and
a position controller configured to receive the occupant presence signal and adjust a position of the vehicle seat to a predetermined driving position in response to receiving the occupant presence signal and prior to turning on a vehicle ignition,
wherein the position controller is configured to wait a predetermined length of time after receiving the occupant presence signal to adjust the position of the vehicle seat to the predetermined driving position and
wherein the position controller is configured to adjust the position of the vehicle seat to a predetermined park position after the vehicle is turned off.

20. The vehicle of claim 19, wherein adjusting the position of the vehicle seat includes at least one of tilting the vehicle seat, reclining the vehicle seat, and moving the vehicle seat in at least one of the following directions: forward, backward, up, and down.

21. The system of claim 9, wherein the predetermined length of time enables the position controller to confirm that the occupant is fully seated in the vehicle seat.
